(19) United States
(12) Patent Application Publication
(10) Pub. No.: US 2022/0134763 A1
(43) Pub. Date: May 5, 2022

(54) CAPS FOR FLUID EJECTION PERIPHERALS

(71) Applicant: Hewlett-Packard Development Company, L.P., Spring, TX (US)

(72) Inventors: Michelle Forshager Ellis, Vancouver, WA (US); Kevin Lo, Vancouver, WA (US); Wonmo Koo, Vancouver, WA (US); Saurabh Shripad Bhide, Vancouver, WA (US)

(73) Assignee: Hewlett-Packard Development Company, L.P., Spring, TX (US)

(21) Appl. No.: 17/434,035

(22) PCT Filed: Jul. 11, 2019
(86) PCT No.: PCT/US2019/041388

§ 371 Date: Aug. 26, 2021

(51) Int. Cl. B41J 2/175; B41J 2/165

(52) U.S. Cl. CPC B41J 2/1754; B41J 2/16511

(57) ABSTRACT

Present examples relate to fluid ejection peripherals for, non-limiting example, ink jet peripherals. More specifically, but without limitation, present examples relate to caps for fluid ejection peripherals which may be locked or unlocked relative to the peripheral device.

### BACKGROUND

Present examples relate to fluid ejection peripherals, for non-limiting example, ink jet peripherals. More specifically, but without limitation, present examples relate to caps for fluid ejection peripherals which may be locked or unlocked relative to the fluid ejection peripheral.

### BRIEF DESCRIPTION OF THE DRAWINGS

FIG. 1 is a perspective view of a cap for a fluid ejection peripheral;

FIG. 2 is an upper perspective view into the interior of the cap;

FIG. 3 is a top view of the cap showing the locks in a first un-locked position;

FIG. 4 is a top view showing the locks in a locked position;

FIG. 5 is a perspective view of the rotatable base removed from the cap;

FIG. 6 is a perspective view of the base of FIG. 5 with the top removed;

FIG. 7 is an upper perspective view of the cap with the locks removed and portions of the base shown;

FIG. 8 is a view of the cam and follower structures of the locks shown in first and second positions;

FIG. 9 is a bottom view of the lower surface of a floor of the cap which is adjacent to the base;

FIG. 10 is a sectioned perspective view of the assembled cap with one of the locks shown in first and second positions; and,

FIG. 11 is a sequence view showing a sequence of the cap changing from a locked to an unlocked condition.

### DETAILED DESCRIPTION

Fluid ejection peripherals, for example ink jet peripherals, are capable of leaking fluid during transportation. As more of these devices become mobile in nature, there exists a need for structures to inhibit leakage of fluid or ink from the peripheral device. Additionally, when ejection heads, or pens are left exposed to open air, there may also be a tendency to dry.

For the above reasons, there may be a desire to cover the fluid ejection heads associated with these peripherals. Further, it may be desirable to have a positive feedback when a cap structure is locked on the peripheral or when the structure is unlocked for positive assurance of the user that the cap structure is in a desired position.

Caps for a fluid ejection peripheral are provided but are not limited in application to the details of construction and the arrangement of components set forth in the following description or illustrated in the drawings. The described examples are capable of other examples and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

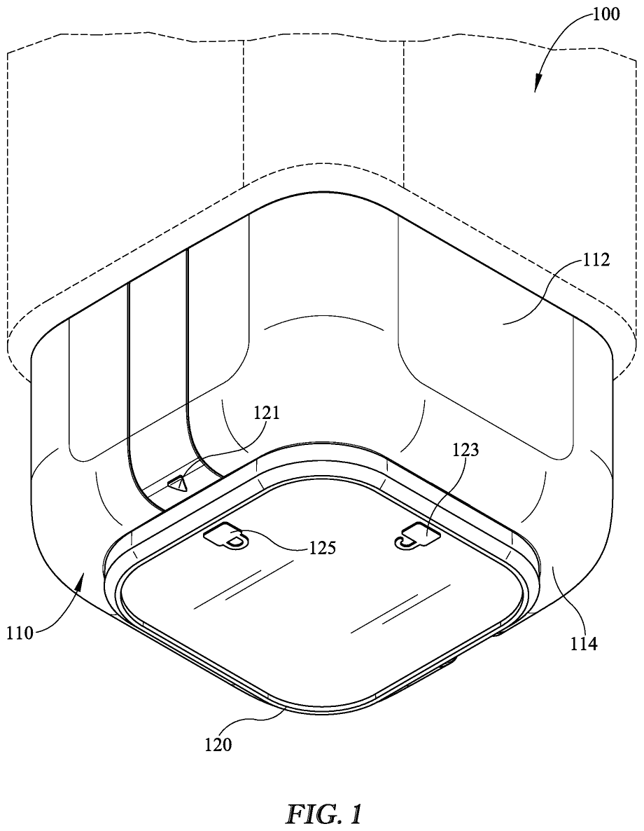

Referring now to FIGS. 1-11, various examples of a fluid ejection peripheral are shown and more specifically, but without limitation, a cap for the fluid ejection peripheral is provided. The cap may be locked or unlocked relative to the peripheral in order to inhibit leakage and drying of the fluid which ejected from the peripheral. The cap may be locked or unlocked and provides an aesthetic and desirable functionality for a user to provide positive feedback to the user of the locked or unlocked condition of the cap relative to the peripheral.

With reference to FIG. 1, a cap 110 is shown positioned beneath a schematically depicted fluid ejection peripheral 100, for example an ink jet peripheral according to some examples. The cap 110 may be locked to, by pivoting of base 120, or may be released from, by the pivoting of the base 120, the cap 110. The cap 110 may have a surrounding wall 112, which may be one wall or multiple walls to define a desired shape for the cap 110. The cap 110 also comprises a floor 114 at a lower end of the surrounding wall 112. The floor 114 generally extends from a lower peripheral edge of the one wall 112 to enclose the bottom of the cap 110. The upper end of the cap 110 may be open ended to engage or receive a portion of the peripheral device 100, for example a print head, pen, or like portion of the fluid ejection peripheral.

At the bottom of the cap 110, beneath the floor 114, may be the base 120. The base 120 may be rotatable relative to the cap 110 and the rotational position may determine the locked or unlocked condition of the cap 110 relative to the peripheral device 100. The base 120 and or cap 110 may include indicia 123, 125 to indicate to the user the current condition of the cap 110 relative to the peripheral device 100. That is, the indicia 123, 125 of the base 120 may indicate, for example, whether the cap 110 is locked or unlocked, for example. The cap 110 may have also have a reference indicia 121 on one of the cap 110 or base 120 to indicate to a user: (a) where to look, and (b) aid in determining the locked or unlocked condition of the cap 110. In the instant view, the reference indicia 121 is aligned with indicia 125 to visually indicate to a user that the cap 110 is in a locked position.

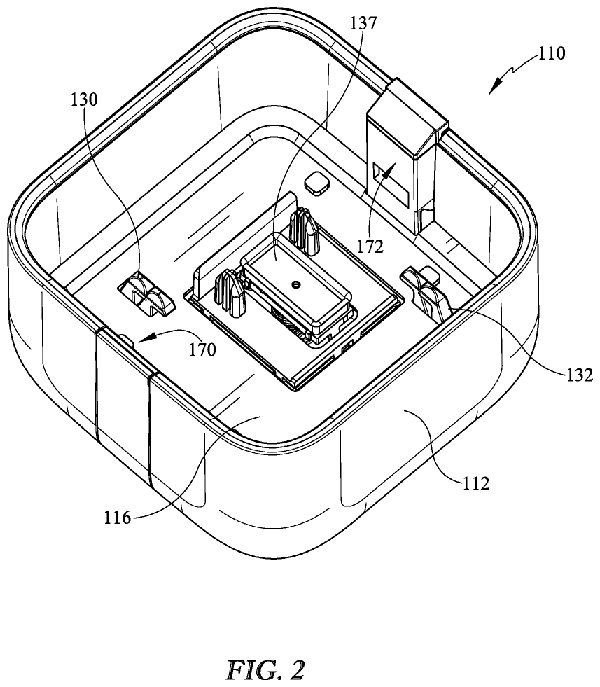

Referring now to FIG. 2, the cap 110 is shown in an upper perspective view. The surrounding wall 112 are shown defining an upper opening for the cap 110. The height of the wall 112 may define the depth of the cavity within the cap 110. The surrounding wall 112 extend downwardly to a floor 114. A floor cover 116 may be disposed on top of the floor 114 and the locks 130, 132 may extend through the floor covering 116. The locks 130, 132 are each shown in two positions, one an unlocked position which is closer to the surrounding wall 112, and second a locked position which is further inward from the surrounding wall 112. Additionally shown within the cap 110 is a pen housing 137 which may engage a pen, print head or other fluid ejection structure of the peripheral device 100.

Additionally, along the top edge of the surrounding wall 112 are orientation indicators 170, 172. The orientation indicators 170, 172 are not symmetrical and provide a visual structure which the user can utilize to determine how and where to apply the cap 110 to the peripheral device 100 (FIG. 1). The orientation indicators 170, 172 also function as a key or keyway in applying the cap 110 to the peripheral so that the cap 110 may be applied in one correct orientation. Alternatively, if the cap 110 is applied incorrectly to the peripheral, the cap 110 may be incapable of locking. Further the orientation indicators 170, 172 also minimizes the rotational freedom of the peripheral device 100 inside the cap 110. This is desirable due to the varying moments which may be applied via the base 120, or via the peripheral device 100 when the base 120 is frictionally pressed against a surface. As shown, the orientation indicators 170 is of a first size and may have structure extending inwardly from the surrounding wall 112 and may function as a key or keyway feature. The second orientation indicator 172 is of a smaller size. One or both of the orientation indicators 170, 172 may also hook or catch on corresponding structure of the peripheral device 100. However, the differing size or shape, or both, may provide the ability to orient the cap 110 in a single direction relative to the peripheral device 100.

In function, the cap 110 may be moved against the peripheral device such that the pen housing 137 engages or covers the print head, for example in a sealed manner. This inhibits leakage and drying of the print head (not shown). Subsequently, the base 120 (FIG. 1) may be rotated so that the locks 130, 132 move between the unlocked position and the locked positions shown in FIG. 2. When ready for use, the cap 110 may be unlocked by rotating the base 120 and the cap 110 removed.

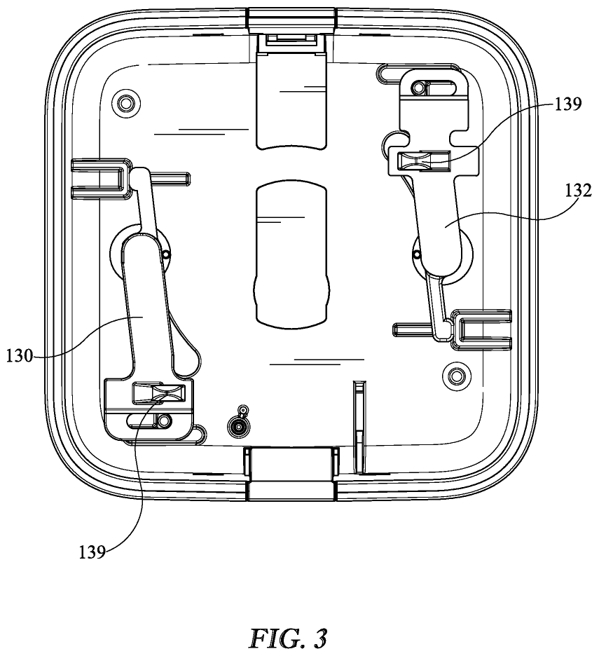

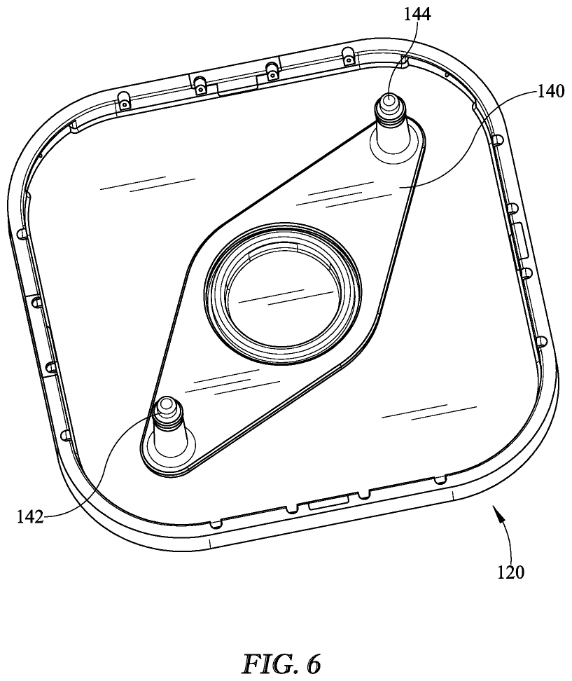

Referring now to FIG. 3, a top view of the cap 110 is shown. In this view, the floor cover 116 is removed to reveal additional portions of the locks 130, 132 beneath the floor cover 116. By comparison with FIG. 2, the locks 130, 132 comprise hooks or catches 139 which extend above the floor cover 116. The locks 130, 132 are movable between first and second positions corresponding to the locked and unlocked positions of the cap 110, relative to the peripheral 100 (FIG. 1). The rotational movement of the base 120 (FIG. 1) causes linear movement of the locks 130, 132 by way of cam 140 (FIG. 6) and follower structures 134, 136 of the locks 130, 132. Other structures may be used to transmit movement of the base 120 to the locks 130, 132 and the movement may be, but is not limited to, rotational to linear motion.

In the top view of FIG. 3, the locks are shown slidably positioned outwardly toward the surrounding wall 112 which depicts an unlocked position. This may alternatively be an unlocked position if hooks, catch, or other locking structures are changed in orientation.

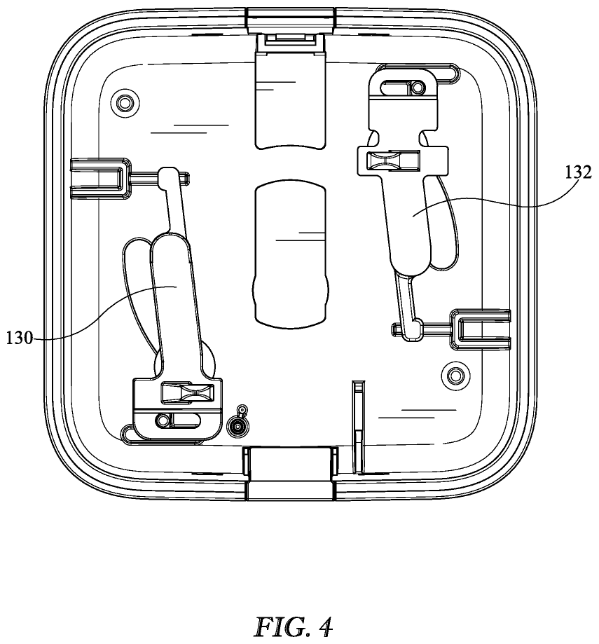

With additional reference to FIG. 4, the base 120 (FIG. 1) has been rotated and accordingly the locks 130, 132 are moved inwardly to a locked position.

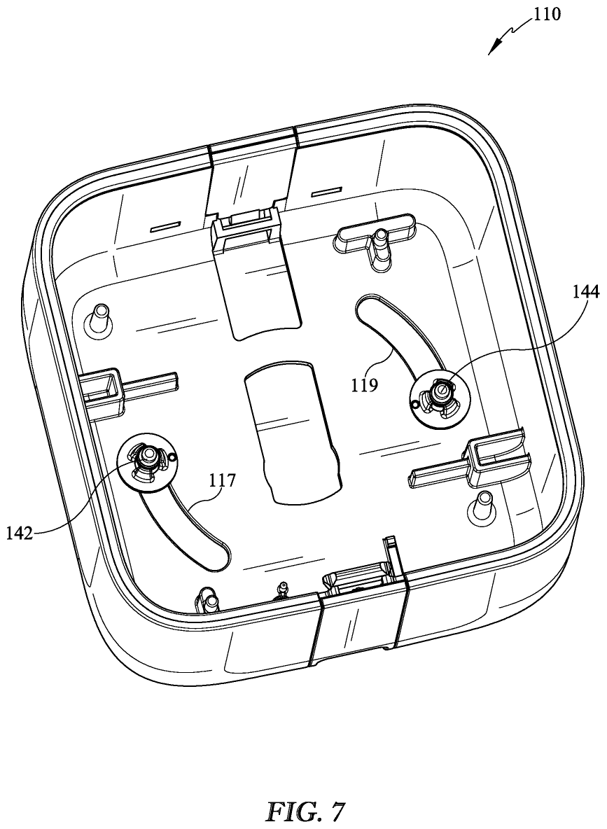

The locks 130, 132 are moved generally linearly by the rotational movement of the base 120 (FIG. 1). The amount of rotation of the base 120 may control the amount of movement of the locks 130, 132 or the amount of rotation may be indirectly related to the amount of motion of the locks 130, 132. Posts 142, 144 (FIG. 7) extend through the floor 114 (FIG. 1) and rotate with the base 120. The posts 142, 144 engage the locks 130, 132, to drive movement of the locks 130, 132.

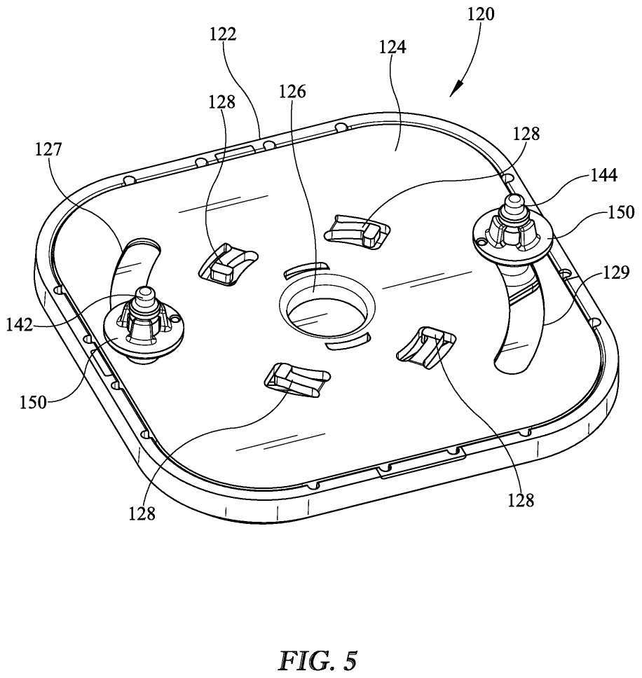

Referring now to FIG. 5, a perspective view of the base 120 is shown removed from the cap 110 (FIG. 1). According to some examples, the base 120 may be square in shape but may be of various other geometries which are capable of being grasped and rotated by the user. The base 120 may also be formed of various materials and according to some examples, may be formed of a tacky or high friction/low slip material. Accordingly, when the cap 110 is locked to the peripheral device 100 (FIG. 1), the peripheral device 100 may be pushed against a reference surface that the base 120 frictionally engages so that rotation of the peripheral device 100 causes rotation of the cap 110 relative to the base 120.

The base 120 is shown generally with a peripheral edge 122, a hollow interior, and may comprise a top 124 extending across the base 120 and through the interior. The top 124 may include an aperture 126 for pivotal engagement with the cap 110, as well as a plurality of snap hooks 128 which engage the cap 110 to provide tactile feedback to the user, indicating locked or unlocked engagement. The top 124 may also include first and second guide grooves 127, 129 through which posts 142, 144 of the cam 140 (FIG. 6) extend. The posts 142, 144 extend upwardly through the guides 127, 129 and into the cap 110 (FIG. 7). Each of the posts 142, 144 may have a retaining structure 150, which is shown in FIGS. 5 and 7, in order to retain the posts 142, 144 through the cap 110 and in position.

With additional reference to FIG. 6, the base 120 is shown with the top 124 (FIG. 5) removed. The cam 140 is shown disposed within the base 120 and may be any of various shapes which locate the posts 142, 144 in desired positions to extend through the guide grooves 127, 129 (FIG. 5) and the floor 114 (FIG. 5). With rotation of the base 120, the posts 142, 144 move through the guide grooves 127, 129 (FIG. 5) and the guide slots 117, 119 (FIG. 7) in the floor 114 (FIG. 1). The cam 140 is capable of movement relative to the base 120 and the base top 124.

With reference now to FIG. 7, an upper perspective view of the cap 110 is shown. The floor cover 116 (FIG. 2) and the locks 130, 132 (FIG. 2) are removed to reveal the posts 142, 144 extending through the guide slots 117, 119 in the floor 114 of the cap 110. The rotation of the base 120 causes the posts 142, 144 to move through the guide slots 117, 119 in the floor 114 (FIG. 1) of the cap 110. The posts 142, 144 function with the cam 140 (FIG. 6) to drive motion of the locks 130, 132 within the cap 110.

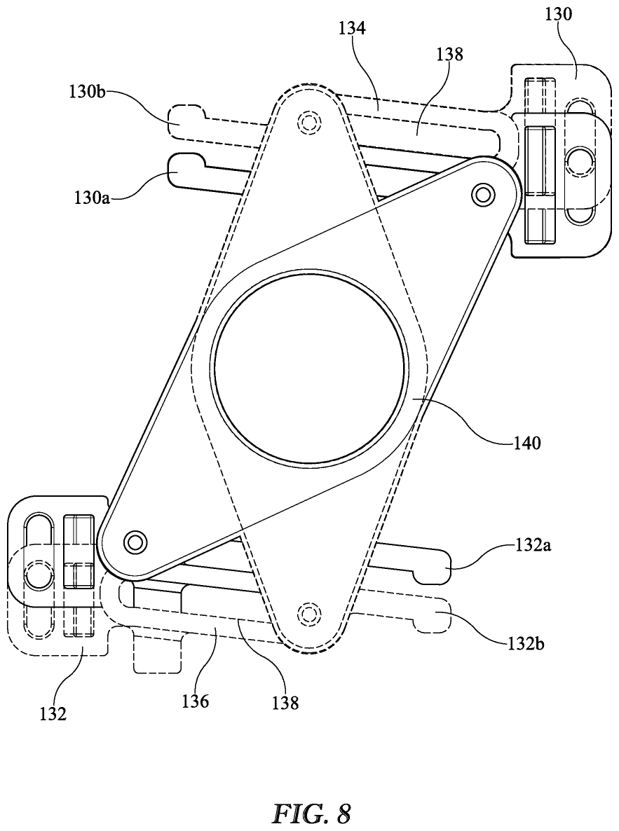

Referring now to FIG. 8, the locks 130, 132 and cam 140 are shown in two positions. In one position, the locks 130, 132 are moved inwardly (130a, 132a) as related to the rotational position of the cam 140 and the posts 142, 144 (not shown). A second position is shown in broken line where the locks 130b, 132b are moved outwardly. The cam 140 is rotated from the previous position which drives motion of the locks 130, 132 and the follower structures 134, 136 of the locks 130, 132.

As also shown, the follower structures 134, 136 may comprise slide path 138 which are engaged by the posts 142,144 such that movement of the cam 140 and the posts 142, 144 results in movement of the posts 142, 144 through, and of, the slide path 138 and follower structures 134, 136. As a result of this rotational movement, linear movement of the locks 130,132 is provided.

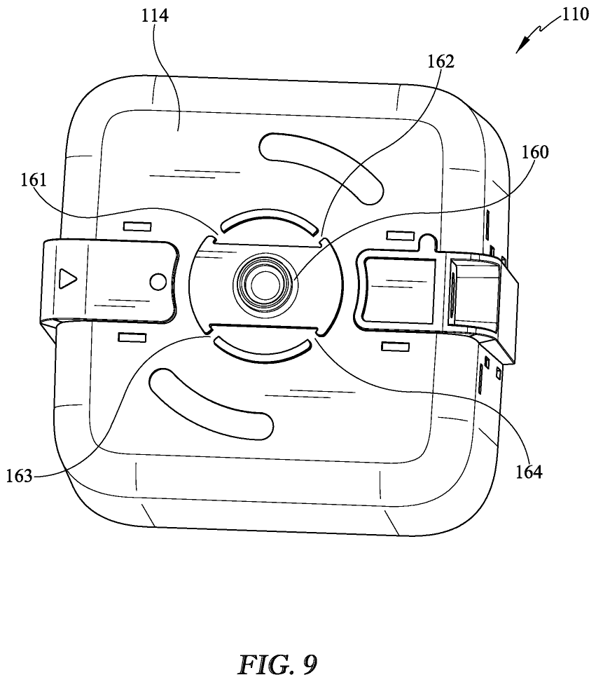

Referring now to FIG. 9, a bottom view of the cap 110 is depicted. In this view, the base 120 (FIG. 1) is removed to reveal a lower surface of the floor 114. On the bottom of the floor 114 is a pivot 160 which engages the base 120 and allows the base 120 to rotate relative to the cap 110, or vice versa. Also shown on the lower surface of the floor 114, are detents 161, 162, 163, 164 which receive the snap hooks 128 (FIG. 5) located in the top 124 of the rotating base 120. These detents 161, 162, 163, 164 provide a tactile feel for the user when the base 120 is rotated to specific positions. For example, the detents 161, 162, 163, 164 are spaced apart 90 degrees from one another and when the base 120 rotates, the snap hooks 128 engage the detents 161, 162, 163, 164 at specific positions, which provides a feel to the user that the cap 110 is either locked or unlocked. The detents 161, 162, 163, 164 and the snap hooks 128 may be of varying size so as to provide specific feel or provide more tactile feedback to the user indicating either of the locked or unlocked positions. Further, the sizing may also aid in disengaging the snap hook 128 from the detent 161, 162, 163, 164 when rotated in, for example, a specific position or a specific direction.

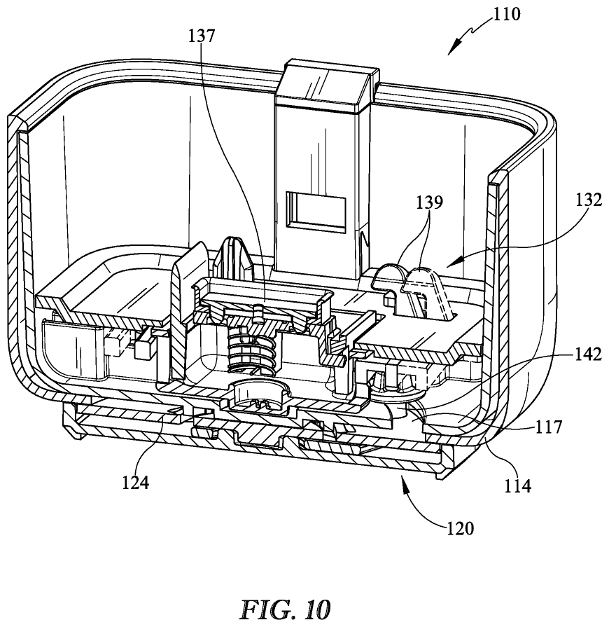

Referring now to FIG. 10, a sectioned perspective view of the cap 110 is depicted. The section view is cut through the center of the cap 110 and shows hooks 139 of one of the locks 132 in two differing positions.

As shown in the view, the cap 110 has the base 120 disposed beneath the floor 114 and the base 120 is pivotally connected to the floor 114 of the cap 110. The base top 124 is also shown disposed between the base 120 and the floor 114. The posts 142, 144 extend through the base top 124 from the cam 140 disposed in the base 120 and between the base top 124 and the base 120. The posts 142, 144 extend through the guide slots 117, 119 (FIG. 7) of the floor 114 and engage the locks 130,132. More specifically, the posts 142,144 are located within the slide path 138 of the follower structure 134, 136 portion of the locks 130, 132 so as to move the hooks between the first and second position shown, depending on the rotational position of the base 120 relative to the cap 110.

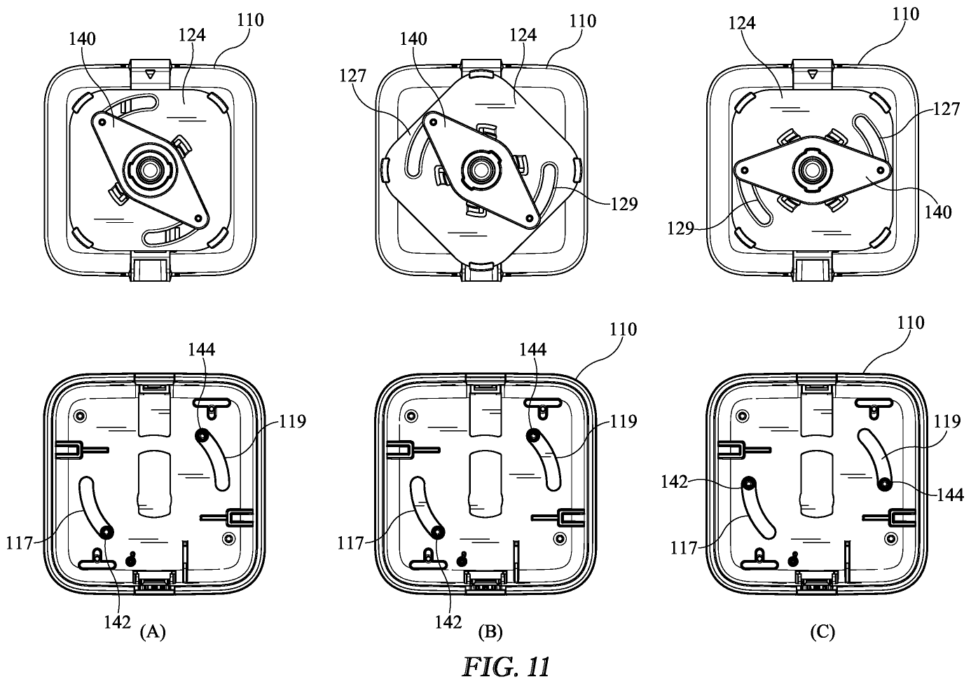

Referring now to FIG. 11, three sequence views are shown each relating to movement of the base 120 (FIG. 1) relative to the cap 110 behind. The pivoting of the base 120 occurs about a vertical axis, or through a horizontal plane, but this may vary depending on the orientation of the cap 110 and base 120 during the pivoting operation. Each operation of the sequence is shown with a pair of views, bottom and top views, and are generally referred to as operations A, B, and C. Each of the bottom views is depicted with the base removed, to show operation of the base internals, the base top 124 and the cam 140. Each of the top views shows the cap 110 from the opposite side looking internally into the cavity and depicting the positions of the posts 142, 144 during the sequence. The posts 142, 144 also represent the movement of the cam 140.

In the views depicted, at the left hand side of the sequence, the cap 110 begins in a locked position at operation A and changes to an unlocked position at the last sequence view operation C.

Referring now to the first operation A of the sequence, the base 120 is removed so that the base top 124 and the cam 140 are shown. In these positions, the base 120, which is removed, would be positioned adjacent to the cam 140 and in the same position shown as the base top 124. The cam 140 is capable of movement relative to the base 120 and the base top 124. Friction between the posts 142, 144, or the retaining structures 150, and the cap 110 retains the cam 140 and the posts 142, 144 in the position depicted. With reference to the lower view of the sequence operation A, the posts 142, 144 are shown in lower and upper positions of the guide slots 117, 119.

Referring now to sequence operation B, the base 120 is rotated in a counter-clockwise direction and consequently the base top 124 is shown moved 45 degrees from its position in sequence operation A. During this move from operation A to operation B, the friction between the retainers 150 and the cap 110, may preclude movement of the cam 140. The guide grooves 127, 129 move relative to the posts 142, 144 of the cam 140. The cam 140 is in the same position as it was in sequence operation A and therefore is not moved relative to the cap 110. This is shown in the top view of the cap 110 which depicts the posts 142, 144 in the same position of the guide slots 117, 119 as in sequence operation A.

The base top 124 has the guide grooves 127, 129 that extend arcuately about 45 degrees. When the base top 124 rotates the first 45 degrees and the cam 140 is held in place by friction, the base top 124 relative to the cam 140, moves without moving the cam 140. During the initial movement of the base top 124, the guide grooves 127, 129 move past the posts 142, 144. In the view depicted in sequence operation B, the base top 124 is rotated so that the posts 142, 144 are engaging the second ends of the guide grooves 127, 129. At this position, further movement of the base top 124 will cause motion of the cam 140.

Referring now to sequence operation C, the base top 124 is rotated 45 degrees further from operation B. Accordingly, the total movement of the base top 124 is 90 degrees. The second end of the guide grooves 127, 129 engages the posts 142, 144 and forces movement of the posts 142, 144, and cam 140. However, whereas the base top 124 is moved 90 degrees from its position in operation A, the cam 140 has moved 45 degrees from its position in sequence operation A. Further, with the top view of the cap of sequence operation C, the posts 142, 144 are shown moved 45 degrees from the position in sequence operation A and B. The guide slots 117, 119 are offset by 45 degrees from the guide grooves 127, 129 of the base top 124. When the posts 142, 144 begin moving between operations B and C, the guide slots 117, 119 allow for movement of the posts relative to the floor 114 and cap 110. This offset allows for the 90 degree movement of the base top 124 and base 120, while moving the cam 140 through 45 degrees. The described arcuate distances are illustrative and not limiting and therefore other distances may be moved. For example, the base 120 provides for movement of a first arcuate distance while the cam 140 moves a second distance which is less than the first distance. While the foregoing is directed to the various examples described, other and further examples may be devised without departing from the basic scope of the claims that follow. For example, the present examples contemplate that any of the features shown in any of the examples described herein, or incorporated by reference herein, may be incorporated with any of the features shown in any of the other examples described herein, or incorporated by reference herein, and still fall within the scope of the present claims.

1. A fluid ejection apparatus, comprising:
a cap having a surrounding wall;
a floor that encloses one side of the surrounding wall;
a cavity defined by the surrounding wall and the floor; and
a base disposed along an exterior side of the floor, wherein the base is to pivot relative to the cap through an arcuate distance and in a horizontal plane;
wherein the cap is retained on or released from the fluid ejection apparatus by the pivot of the base.

2. The fluid ejection apparatus of claim 1, further comprising movable locks within the cavity.

3. The fluid ejection apparatus of claim 2, wherein the movable locks are to move with movement of the base.

4. The fluid ejection apparatus of claim 1, wherein the base has a cam that moves within the base.

5. The fluid ejection apparatus of claim 4, wherein the cam has a first post and a second post.

6. The fluid ejection apparatus of claim 5, wherein the first and second posts engage a respective follower of movable locks within the cavity.

7. The fluid ejection apparatus of claim 5, wherein the first and second posts move through a first arcuate distance as the base moves through a second arcuate distance.

8. A cap for use with a fluid ejection apparatus, comprising:
a floor and a surrounding wall that extends from the floor, together which define a cavity;
a plurality of locks within the cavity;
a base beneath the floor, wherein the base is to pivot relative to the floor about a vertical axis; and
a plurality of locks within the cavity and connected to the base, wherein the plurality of locks are movable with the base;
wherein the base is to pivot through a preselected arcuate distance and the locks are to move through a path to either a locked position or an unlocked position; and
wherein one of the base or floor has detents to retain the cap and base in either a locked or unlocked position.

9. The cap of claim 8, the other of the base or the floor having snap hooks to engage the detents.

10. The cap of claim 8, wherein the floor further comprises a first slot and a second slot.

11. The cap of claim 10, further comprising first and second posts that extend from the base through the slots.

12. The cap of claim 8, wherein surrounding wall has an orientation indicator that is to aid orientation of the cap.

13. A fluid ejection peripheral, comprising:
a cap having a cavity defined by a floor and a wall extending from a periphery of the floor;
a base beneath the floor and exterior of the cavity, the base is to pivot through a horizontal plane;
a lock disposed within the cavity, wherein the lock is to move with the pivotal movement of the base; and
a cam which is to move with the pivotal movement of the base, and a follower which is engagable by the cam;
wherein the lock is to move with the follower; and
wherein the lock moves linearly with the pivotal movement of the base.

14. The fluid ejection peripheral of claim 13, wherein the cam further comprises a post that extends through a guide slot in the floor.

15. The fluid ejection peripheral of claim 14, wherein the follower is a groove which is to receive the post, the groove formed in a body of the lock.
